(19) United States
(12) Patent Application Publication
(10) Pub. No.: US 2022/0127494 A1
(43) Pub. Date: Apr. 28, 2022

(54) METHOD OF COATING A SUBSTRATE, A COATED SUBSTRATE AND RELATED COMPOSITIONS THEREOF

(71) Applicant: Agency for Science, Technology and Research, Singapore (SG)

(72) Inventors: Warintorn THITSARTARN, Singapore (SG); Siok Wei TAY, Singapore (SG); Chee Chuan Jayven YEO, Singapore (SG); Qi Feng LIM, Singapore (SG)

(21) Appl. No.: 17/569,272

(22) Filed: Jan. 5, 2022

Related U.S. Application Data
(62) Division of application No. 17/042,753, filed on Sep. 28, 2020.

(30) Foreign Application Priority Data
Mar. 29, 2018 (SG) 10201802691V

(51) Int. Cl. C09D 183/08; B32B 27/08; B32B 27/28; B32B 33/00; C08G 77/26

(52) U.S. Cl. CPC C09D 183/08; B32B 27/08; B32B 2250/24; B32B 33/00; C08G 77/26; B32B 27/283

(57) ABSTRACT

There is provided a method of coating a substrate, a coated substrate and related compositions thereof. Also provided is a composition for preparing a substrate for coating with a coating layer, the composition comprising an organosilane represented by general formula (I), a catalytic agent and an organic solvent.

(Y—R)ₙSiXₘ (I)

### CROSS-REFERENCE TO RELATED APPLICATIONS

This application is a divisional of U.S. patent application Ser. No. 17/042,753, filed Sep. 28, 2020, which is a U.S. National Stage Application of PCT International Application No. PCT/SG2019/050178, filed Mar. 29, 2019, which claims priority to Singapore Patent Application No. 10201802691V, filed Mar. 29, 2018, the disclosures of which are incorporated by reference herein in their entireties.

### TECHNICAL FIELD

Various embodiments disclosed herein relate broadly to compositions for preparing a substrate for coating with a coating layer, methods of coating a substrate and coated substrates.

### BACKGROUND

Coating substrates that are uneven, rough, contaminated, inert and/or have low interactions with the coating (for e.g. paint) present major challenges. Current coatings applied on such substrates (for e.g. carbon fiber reinforced plastics) often have low durability and short life span, i.e. coatings peel away easily and earlier than the predetermined time.

Attempts have been made to use abrasives and solvent wiping to prepare the substrate surfaces just before coating. However, relying on these physical methods themselves do not prove to be suitable. Using abrasives such as sanding is labour intensive and skill dependent, and solvent wiping undesirably leaves a lot of residues on the substrate surfaces which may subsequently also affect the ability of the coating to properly adhere to the substrate surface.

Known methods of using more sophisticated techniques of surface treatment or surface modification with an aim of improving coating adhesion and adhesion durability are also associated with several problems.

For example, in surface treatments using primers, a primer is usually applied on a substrate (for e.g. plastic substrate) to act as a binder between a top coat layer and the substrate. However, this method of applying a primer is restrictive in that a particular primer is typically required/applicable for a particular substrate and coating.

On the other hand, surface modification methods such as using plasma treatment to modify surface affiliation to make the surface of the substrate hydrophilic through the generation of surface functional groups are faced with its own drawbacks. These drawbacks include the limited and relatively short duration of surface activity observed and the problematic consequence of moisture absorption on the substrate surface after plasma treatment. These drawbacks eventually reduce the coating adhesion and does not enable plasma treatment to be viewed as an ideal solution, particularly on difficult-to-coat substrates such as carbon fiber reinforced plastics.

In view of the above, there is thus a need to address or at least ameliorate one of the problems described above.

### SUMMARY

In one aspect, there is provided a composition for preparing a substrate for coating with a coating layer, the composition comprising:

(i) an organosilane represented by general formula (I):

(Y—R)ₙSiXₘ
wherein
each of Y is independently a chemical moiety that is capable of chemically coupling to a functional group of the coating layer;
each of R is independently a C₃₋₁₈ alkyl group;
each of X is independently a C₁₋₆ alkoxy group;
n is 1, 2 or 3;
m is 1, 2 or 3; and wherein
n+m=4;

(ii) a catalytic agent; and

(iii) an organic solvent.

In one embodiment, the amount of organosilane present is in the range of 0.1 wt % to 22.5 wt %.

In one embodiment, the amount of catalytic agent present is in the range of 0.1 wt % to 2.7 wt %.

In one embodiment, the amount of organic solvent present is in the range of 0.1 wt % to 97.4 wt %.

In one embodiment, each of Y is a chemical moiety independently selected from the group consisting of amine, halogen, vinyl, acryloyloxy, glycidyloxy, hydrogen and aryl.

In one embodiment, the organosilane comprises an aminoalkyl alkoxysilane compound selected from the group consisting of aminopropyltrimethoxysilane, aminobutyltrimethoxysilane, aminopentyltrimethoxysilane, aminohexyltrimethoxysilane, aminopropyltriethoxysilane, aminopropyltripropoxysilane, aminopropyltributoxysilane, aminopropyltripentoxysilane, aminopropyltrihexoxysilane, aminobutyltriethoxysilane, aminobutyltripropoxysilane, aminobutyltributoxysilane, aminobutyltripentoxysilane, aminobutyltrihexoxysilane, aminopentyltriethoxysilane, aminopentyltripropoxysilane, aminopentyltributoxysilane, aminopentyltripentoxysilane aminopentyltrihexoxysilane, aminohexyltriethoxysilane, aminohexyltripropoxysilane, aminohexyltributoxysilane, aminohexyltripentoxysilane and aminohexyltrihexoxysilane.

In one embodiment, the catalytic agent comprises a base selected from the group consisting of methanolamine, ethanolamine, diethanolamine, triethanolamine, propanolamine, butanolamine, trimethylamine, triethylamine, tripropylamine, tributylamine, ammonium hydroxide, tetramethylammonium hydroxide, tetraethylammonium hydroxide, tetrapropylammonium hydroxide and tetrabutylammonium hydroxide.

In one embodiment, the organic solvent is selected from the group consisting of acetone, ethyl acetate, ethyl alcohol, benzene, toluene, xylene and styrene.

In one aspect, there is provided a method of coating a substrate, the method comprising:

applying a layer of the composition as disclosed herein to a surface of the substrate.

In one embodiment, the method further comprises, prior to applying the layer of the composition, subjecting the substrate to plasma treatment to activate the surface of the substrate.

In one embodiment, the plasma treatment is atmospheric plasma treatment.

In one embodiment, the method further comprises, cleaning the surface of the substrate with an organic solvent prior to the step of subjecting the substrate to plasma treatment.

In one embodiment, the method further comprises, drying the layer of the composition after the layer of composition has been applied to the substrate.

In one embodiment, the method further comprises, applying at least one of a primer layer, a topcoat layer or mixtures thereof over the layer of the composition.

In one embodiment, the substrate is selected from the group consisting of polymer, fabric, composite material, fiber reinforced polymer.

In one embodiment, the substrate comprises carbon fiber reinforced plastics.

In one embodiment, the substrate is contaminated with organic and/or inorganic contaminants.

In one embodiment, the substrate is contaminated with one or more hydrocarbon(s) selected from the group consisting of de-icing fluid, jet oil, jet fuel, hydraulic fluid and degreaser.

In one aspect, there is provided a coated substrate comprising: a layer of the composition as disclosed herein that is chemically coupled to a surface of the substrate.

In one embodiment, the coated substrate further comprises: a layer of at least one of a primer, a topcoat or mixtures thereof that is chemically coupled to the layer of the composition.

In one embodiment, the coated substrate has one or more of the following properties: cross-hatch classification of at least 4 as measured by cross-hatch tape test (ASTM D3359), adhesion strength of at least 2 MPa after 6 months of coating as measured by pull-off strength test (ASTM 4541D) at room temperature and adhesion strength of at least 2 MPa after 3 months of coating as measured by pull-off strength test (ASTM 4541D) at 88° C.

### Definitions

The term “substrate” as used herein is to be interpreted broadly to refer to any physical structure to which a coating may be applied.

The term “layer” when used to describe a first material is to be interpreted broadly to refer to a first depth of the first material that is distinguishable from a second depth of a second material. The first material of the layer may be present as a continuous film, as discontinuous structures or as a mixture of both. The layer may also be of a substantially uniform depth throughout or varying depths. Accordingly, when the layer is formed by individual structures, the dimensions of each of individual structure may be different. The first material and the second material may be same or different and the first depth and second depth may be same or different.

The terms “coupled” or “connected” or grammatical variations thereof as used in this description are intended to cover both directly connected or connected through one or more intermediate means, unless otherwise stated. Accordingly, the term “coupling agent” as used herein is to be interpreted broadly to include, but is not limited, to an agent (that may act as the single or one of the many intermediate means) that couples two or more entities together permanently or temporarily. The entities may be organic or inorganic and the coupling means between the agent and the entities includes, but is not limited to physical, chemical or biological bonding/interaction.

The term “and/or”, e.g., “X and/or Y” is understood to mean either “X and Y” or “X or Y” and should be taken to provide explicit support for both meanings or for either meaning.

Further, in the description herein, the word “substantially” whenever used is understood to include, but not restricted to, “entirely” or “completely” and the like. In addition, terms such as “comprising”, “comprise”, and the like whenever used, are intended to be non-restricting descriptive language in that they broadly include elements/components recited after such terms, in addition to other components not explicitly recited. For example, when “comprising” is used, reference to a “one” feature is also intended to be a reference to “at least one” of that feature. Terms such as “consisting”, “consist”, and the like, may in the appropriate context, be considered as a subset of terms such as “comprising”, “comprise”, and the like. Therefore, in embodiments disclosed herein using the terms such as “comprising”, “comprise”, and the like, it will be appreciated that these embodiments provide teaching for corresponding embodiments using terms such as “consisting”, “consist”, and the like. Further, terms such as “about”, “approximately” and the like whenever used, typically means a reasonable variation, for example a variation of +/−5% of the disclosed value, or a variance of 4% of the disclosed value, or a variance of 3% of the disclosed value, a variance of 2% of the disclosed value or a variance of 1% of the disclosed value.

Furthermore, in the description herein, certain values may be disclosed in a range. The values showing the end points of a range are intended to illustrate a preferred range. Whenever a range has been described, it is intended that the range covers and teaches all possible sub-ranges as well as individual numerical values within that range. That is, the end points of a range should not be interpreted as inflexible limitations. For example, a description of a range of 1% to 5% is intended to have specifically disclosed sub-ranges 1% to 2%, 1% to 3%, 1% to 4%, 2% to 3% etc., as well as individually, values within that range such as 1%, 2%, 3%, 4% and 5%. The intention of the above specific disclosure is applicable to any depth/breadth of a range.

Additionally, when describing some embodiments, the disclosure may have disclosed a method and/or process as a particular sequence of steps. However, unless otherwise required, it will be appreciated that the method or process should not be limited to the particular sequence of steps disclosed. Other sequences of steps may be possible. The particular order of the steps disclosed herein should not be construed as undue limitations. Unless otherwise required, a method and/or process disclosed herein should not be limited to the steps being carried out in the order written. The sequence of steps may be varied and still remain within the scope of the disclosure.

### DESCRIPTION OF EMBODIMENTS

Exemplary, non-limiting embodiments of a composition for preparing a substrate surface for coating with a coating layer, a method of coating a substrate and a coated substrate are disclosed hereinafter.

In various embodiments, there is provided a composition for preparing a substrate for coating with a coating layer. In various embodiments, preparing a substrate for coating with a coating layer includes preparing or priming one or more surfaces of the substrate so that the substrate is suitable for or capable of being coated with a coating layer. In various embodiments, when the substrate is suitable for or capable of being coated with a coating layer, said substrate may be in a better condition to be coated such that the properties of the coating layer are enhanced, i.e. the coating layer has improved properties such as better coating durability or coating adhesiveness on the substrate.

In various embodiments, the composition comprises a functional group modifier, for example in the form of an organosilane modifying agent. In various embodiments, the composition comprises an organosilane coupling agent; a catalytic agent; and an organic solvent.

In various embodiments, the organosilane is represented by general formula (I):

(Y—R)ₙSiXₘ

In various embodiments, each of R is independently an alkyl group, for example a C₃₋₁₈ alkyl group. In various embodiments, each of R is independently selected from the group consisting of C₃ alkyl, C₄ alkyl, C₅ alkyl, C₆ alkyl, C₇ alkyl, C₈ alkyl, C₉ alkyl, C₁₀ alkyl, C₁₁ alkyl, C₁₂ alkyl, C₁₃ alkyl, C₁₄ alkyl, C₁₅ alkyl, C₁₆ alkyl, C₁₇ alkyl and C₁₈ alkyl. In various embodiments, each of R is independently a C₃₋₆ alkyl group. In various embodiments, R is propyl (i.e. C₃ alkyl), butyl (i.e. C₄ alkyl), pentyl (i.e. C₅ alkyl) or hexyl group (i.e. C₆ alkyl). In some embodiments, R is propyl.

In various embodiments, each of Y is independently a chemical moiety that is capable of chemically reacting, chemically interacting, chemically bonding or chemically coupling with one or more chemical/functional groups of the coating layer (e.g. a functional group in the matrix of the coating layer). In some embodiments, one or more of Y may also be capable of chemically reacting, chemically interacting, chemically bonding or chemically coupling with one or more chemical/functional groups of the substrate. In some embodiments, each of Y is independently a reactive chemical moiety selected from the group consisting of amine, halogen, vinyl, acryloyloxy, glycidyloxy, hydrogen and aryl.

In some embodiments, Y is primary, secondary or tertiary amine. In one embodiment, Y is primary amine.

In various embodiments, each of X is independently an alkoxy group, for example, a C₁₋₆ alkoxy group. In various embodiments, each of X is independently a methoxy (i.e. C₁ alkoxy), an ethoxy (i.e. C₂ alkoxy), a propoxy (i.e. C₃ alkoxy), a butoxy (i.e. C₄ alkoxy), a pentoxy (i.e. C₅ alkoxy) or a hexoxy group (i.e. C₆ alkoxy). In some embodiments, X is methoxy. In various embodiments, each of X is independently a chemical moiety that is capable of chemically reacting, chemically interacting, chemically bonding or chemically coupling with one or more chemical/functional groups of the substrate and/or coating layer.

In various embodiments, each of n and m is an integer. In various embodiments, n is 1, 2 or 3. In various embodiments, m is 1, 2 or 3. In various embodiments, the sum of n and m is 4. In some embodiments, when n is 1, m is 3. In some embodiments, when n is 2, m is 2. In some embodiments, when n is 3, m is 1. As will be appreciate, in some embodiments where n and/or m are more than 1, there may be more than one of Y, more than one of R and/or more than one of X. Accordingly, in such embodiments, each of the plurality of Y may be same or different, each of the plurality of R may be same or different and/or each of the plurality of X may be same or different.

In various embodiments, the organosilane comprises an aminoalkyl alkoxysilane compound selected from the group consisting of aminopropyltrimethoxysilane, aminobutyltrimethoxysilane, aminopentyltrimethoxysilane, aminohexyltrimethoxysilane, aminopropyltriethoxysilane, aminopropyltripropoxysilane, aminopropyltributoxysilane, aminopropyltripentoxysilane, aminopropyltrihexoxysilane, aminobutyltriethoxysilane, aminobutyltripropoxysilane, aminobutyltributoxysilane, aminobutyltripentoxysilane, aminobutyltrihexoxysilane, aminopentyltriethoxysilane, aminopentyltripropoxysilane, aminopentyltributoxysilane, aminopentyltripentoxysilane, aminopentyltrihexoxysilane, aminohexyltriethoxysilane, aminohexyltripropoxysilane, aminohexyltributoxysilane, aminohexyltripentoxysilane, aminohexyltrihexoxysilane and the like and combinations thereof. In one embodiment, aminopropyltrimethoxysilane (APTMS) is used as an organosilane coupling agent. In another embodiment, aminopropyltriethoxysilane (APTES) is used as an organosilane coupling agent.

In various embodiments, the composition comprises a catalytic agent. The catalytic agent may be a catalyst added to catalyse the reaction between the composition and the coating layer and/or to catalyse the reaction between the composition and an activated site of the substrate. In various embodiments, the term “catalyst” and “catalytic agent” can be used interchangeably. Any suitable catalyst that effectively catalyses the reaction between the composition and the coating layer/substrate may be used in embodiments of the composition disclosed herein. In various embodiments, the catalytic agent comprises a base or a base liquid. The base may be selected from the group consisting of alkanolamines, trialkylamines, tetraalkylammonium hydroxides, ammonium hydroxide and the like and combinations thereof. The base may be selected from the group consisting of methanolamine, ethanolamine, diethanolamine, triethanolamine, propanolamine, butanolamine, trimethylamine, triethylamine, tripropylamine, tributylamine, ammonium hydroxide, tetramethylammonium hydroxide, tetraethylammonium hydroxide, tetrapropylammonium hydroxide, tetrabutylammonium hydroxide and the like and combinations thereof.

In various embodiments, the composition comprises an organic solvent. Any suitable organic solvent that effectively serves as a medium to contain the other components of the composition may be used in embodiments of the composition disclosed herein. In various embodiments, the organic solvent is capable of substantially dissolving the components present in the composition. In various embodiments, the organic solvent is a volatile liquid with a high evaporation rate. In various embodiments, the organic solvent has a very low water content or substantially devoid of water. In various embodiments, the water content in the organic solvent is no more than about 0.5%, no more than about 0.45%, no more than about 0.4%, no more than about 0.35%, no more than about 0.3%, no more than about 0.25%, no more than about 0.2%, no more than about 0.15%, no more than about 0.1%, no more than about 0.05%, no more than about 0.01%, no more than about 0.005% or no more than about 0.001%. The organic solvent may be anhydrous. In some embodiments, the organic solvent is selected from the group consisting of acetone, ethyl acetate, ethyl alcohol, benzene, toluene, xylene, styrene, alcohols such as methanol, triethylamine, ethyl benzene, diethanolamine, styrene and the like and combinations thereof.

In various embodiments, the amount of organosilane present is up to 22.5 wt % of the composition, or is in the range of from about 0.1 wt % to 22.5 wt %, from about 0.2 wt % to about 22.4 wt %, from about 0.3 wt % to about 22.3 wt %, from about 0.4 wt % to about 22.2 wt %, from about 0.5 wt % to about 22.1 wt %, from about 1.0 wt % to about 22.0 wt %, from about 1.5 wt % to about 21.5 wt %, from about 2.0 wt % to about 21.0 wt %, from about 2.5 wt % to about 20.5 wt %, from about 3.0 wt % to about 20.0 wt %, from about 3.5 wt % to about 19.5 wt %, from about 4.0 wt % to about 19.0 wt %, from about 4.5 wt % to about 18.5 wt %, from about 5.0 wt % to about 18.0 wt %, from about 5.5 wt % to about 17.5 wt %, from about 6.0 wt % to about 17.0 wt %, from about 6.5 wt % to about 16.5 wt %, from about 7.0 wt % to about 16.0 wt %, from about 7.5 wt % to about 15.5 wt %, from about 8.0 wt % to about 15.0 wt %, from about 8.5 wt % to about 14.5 wt %, from about 9.0 wt % to about 14.0 wt %, from about 9.5 wt % to about 13.5 wt %, from about 10.0 wt % to about 13.0 wt %, from about 10.5 wt % to about 12.5 wt %, from about 11.0 wt % to about 12.0 wt %, or about 11.5 wt % of the composition.

In various embodiments, the amount of catalytic agent present is up to 2.7 wt % of the composition or in the range of from about 0.1 wt % to 2.7 wt %, from about 0.2 wt % to about 2.6 wt %, from about 0.3 wt % to about 2.5 wt %, from about 0.4 wt % to about 2.4 wt %, from about 0.5 wt % to about 2.3 wt %, from about 0.6 wt % to about 2.2 wt %, from about 0.7 wt % to about 2.1 wt %, from about 0.8 wt % to about 2.0 wt %, from about 0.9 wt % to about 1.9 wt %, from about 1.0 wt % to about 1.8 wt %, from about 1.1 wt % to about 1.7 wt %, from about 1.2 wt % to about 1.6 wt %, from about 1.3 wt % to about 1.5 wt %, or about 1.4 wt % of the composition.

In various embodiments, the amount of organic solvent present is up to 97.4% of the composition or in the range of from about 0.1 wt % to 97.4 wt %, from about 0.2 wt % to about 97.3 wt %, from about 0.3 wt % to about 97.2 wt %, from about 0.4 wt % to about 97.1 wt %, from about 0.5 wt % to about 97.0 wt %, from about 1.0 wt % to about 96.0 wt %, from about 2.0 wt % to about 95.0 wt %, from about 4.0 wt % to about 94.0 wt %, from about 6.0 wt % to about 93.0 wt %, from about 8.0 wt % to about 92.0 wt %, from about 10.0 wt % to about 91.0 wt %, from about 15.0 wt % to about 90.0 wt %, from about 20.0 wt % to about 89.0 wt %, from about 25.0 wt % to about 88.0 wt %, from about 30.0 wt % to about 87 wt %, from about 35.0 wt % to about 86.0 wt %, from about 40.0 wt % to about 85.0 wt %, from about 45.0 wt % to about 84.0 wt %, from about 50.0 wt % to about 83.0 wt %, from about 55.0 wt % to about 82.0 wt %, from about 60.0 wt % to about 81.0 wt %, from about 65.0 wt % to about 80.0 wt %, from about 70.0 wt % to about 79.0 wt %, or about 75 wt % of the composition.

In various embodiments, the composition (or the organosiliane coupling agent of the composition) serves as a linker that connects/couples a coating layer and a substrate together. As may be appreciated, functional group Y in the organosilane coupling agent may provide the capability of the coupling agent to react with a functional group of the coating layer and functional group X in the organosilane coupling agent may provide the capability of the coupling agent to interact with an activated site of the substrate surface. Accordingly, in various embodiments, the composition is an adhesion promoter. For example, after being applied to a surface of a substrate, embodiments of the composition disclosed herein react and form a strong and permanent chemical bond with the activated site(s) of the substrate. At the same time, embodiments of the composition disclosed herein are also capable of forming a strong and permanent chemical bond with a coating layer that is applied over the composition. Advantageously, such coupling interactions of the composition with the activated site(s) of the substrate and the coating layer promote the formation of a coating layer that have enhanced coating adhesiveness and prolonged adhesive durability on the substrate as compared to a case when the composition was not applied.

In various embodiments, the composition is fast drying/evaporating. In various embodiments therefore, the composition is applied to the substrate in a simple, fast and direct sol-gel process. In various embodiments therefore, the composition does not require re-formulation and can be applied to the substrate using a wide variety of methods including spin coating, dip coating, spray coating or the like or combinations thereof. In some embodiments therefore, the layer of composition applied on the substrate does not require application of heat, pressure or any complex processes for drying. In some embodiments, the layer of composition is dried at room temperature. In some embodiments, the layer of composition is dried by gentle heating the composition at a temperature that is no more than about 60° C., no more than about 58° C., no more than about 56° C., no more than about 54° C., no more than about 52° C., no more than about 50° C., no more than about 48° C., no more than about 46° C., no more than about 44° C., no more than about 42° C., no more than about 40° C., no more than about 38° C., no more than about 36° C., no more than about 34° C., no more than about 32° C., or no more than about 30° C. In various embodiments, interaction(s) between the one or more functional groups of the silane and the one or more polar groups of the primer layer may be firmed after gentle heating.

In various embodiments, the composition is a surface modifying/surface functionalizing composition. Various embodiments of the composition disclosed herein can be tuned to suit/complement/match the functionality/functional groups present in the coating layer. Various embodiments of the composition disclosed herein are tunable through the customization of the functional groups present in the organosilane coupling agent. In various embodiments, the functional groups present in the organosilane coupling agent are surface active functional groups. Advantageously, in various embodiments, the composition may be tuned to be relatively “universal” in that it has one or more functional groups that generally can couple to the more/most popular functional groups found in most or the majority of paint coats etc. Likewise, the tunability and versality of the composition may also potentially allow it to be applied on many different types of substrates with varying functional groups.

In various embodiments, the coating layer coated on the substrate comprises a layer of the composition. In various embodiments, the coating layer coated on the substrate comprises one or more layer(s) of the composition. In various embodiments, the one or more layer(s) of the composition comprises siloxane linkages. Without being bound by theory, it is believed that, in various embodiments, when the layer(s) of composition containing the organosilane coupling agent is applied to the substrate, the organosilane coupling agent undergoes silanization to form siloxane linkages at the substrate surface. In various embodiments, the coating layer coated on the substrate comprises at least one of a primer layer, a topcoat layer or combinations thereof over the layer(s) of composition. In various embodiments, the coating layer coated on the substrate comprises a matrix such as a paint matrix. In various embodiments, one or more functional groups in the at least one of a primer layer, a topcoat layer or combinations thereof are substantially similar to one or more functional groups in the matrix. The one or more functional groups may be polar group(s) such as C—F bond(s). For example, the at least one of a primer layer, a topcoat layer or combinations thereof may comprise a fluoroelastomer and the matrix (coating) may also comprise fluoroelastomer. Without being bound by theory, it is also believed that, in various embodiments, when the at least one of a primer layer, a topcoat layer or combinations thereof is applied over the layer(s) of composition containing the organosilane coupling agent, there are many different types of reaction(s)/interaction(s) that may occur between said primer layer, topcoat layer or combinations thereof and the organosilane coupling agent, depending on the type/nature of the coating and the type/nature of the functional groups in the organosilane coupling agent. For example, it may be appreciated that when the primer layer comprises fluoroelastomer and the organosilane comprises aminopropyltrimethoxysilane (APTMS), one or more polar groups of the primer (for e.g. carbon-fluorine bonds) may chemically react, chemically bond or chemically couple with the one or more functional groups (for e.g. amine group) of the organosilane. In such embodiments, the at least one of a primer layer, a topcoat layer or combinations thereof interact(s)/reacts(s) with the layer(s) of composition via polar-polar interactions or dipole-dipole intermolecular forces/attractions.

In various embodiments, there is provided a method of coating a substrate, the method comprising: applying a layer of the composition to a surface of the substrate. In various embodiments, the step of applying the layer of composition is simple, fast and direct. In various embodiments, the step of applying the layer of composition is substantially devoid of a re-formulation step and simply comprises spin coating and/or dip coating and/or spray coating and/or brushing the composition on the substrate. In various embodiments, the method further comprises preparing the composition in situ, e.g. mixing the organosilane coupling agent; the catalytic agent; and the organic solvent to form the composition before application on the surface of the substrate. Accordingly, in various embodiments, there is also provided a preparation kit for preparing the composition, the kit comprising the coupling agent; the catalytic agent; and the organic solvent.

In various embodiments, the method further comprises, prior to applying the layer of the composition, subjecting the substrate to plasma treatment to activate the surface of the substrate. In various embodiments, the substrate is activated with plasma treatment before said substrate is added/applied with a layer of composition. In various embodiments, during plasma activation, active sites are created at the surface of the substrate to prepare the substrate for coupling or bonding with the composition. Advantageously, with plasma activation, embodiments of the method disclosed herein allow for the formation of a strong and permanent chemical bond between the activated sites at the substrate and embodiments of the composition disclosed herein, which subsequently promotes the formation of a coating layer having an enhanced coating adhesiveness and prolonged adhesive durability on the substrate.

In various embodiments, the plasma treatment is atmospheric plasma treatment. In some embodiments, the plasma treatment comprises utilizing hand-held atmospheric plasma system to plasma treat the substrate. In various embodiments, the plasma treatment/activation is performed at atmospheric pressure. In various embodiments, the plasma is generated from compressed air. The compressed air includes, but is not limited to, atmospheric air, inert gases or reactive/industrial gases comprising nitrogen, oxygen, carbon dioxide, argon, hydrogen, helium and acetylene. In some embodiments, the plasma treatment is scalable for use at an industrial scale. Embodiments of the method allow for eliminating the use of abrasive methods and harsh chemical treatment methods for surface treatment, thereby making embodiments of the methods environmentally friendly processes.

In various embodiments, the plasma is applied to the substrate at a kV rating of up to about 15 kV or in the range from about 10 kV to 20 kV, from about 11 kV to about 19 kV, from about 12 kV to about 18 kV, from about 13 kV to about 17 kV, from about 14 kV to about 16 kV and an operation power of up to about 2000 W or in the range from about 1500 W to about 2500 W, from about 1600 W to about 2400 W, from about 1700 W to about 2300 W, from about 1800 W to about 2200 W, from about 1900 W to about 2100 W, or about 2000 W.

As may be appreciated, the speed at which the plasma operates may vary and is dependent on the operation power of the plasma. For example, if the operation power is high, the operation speed may be faster. On the other hand, if the operation power is low, the operation speed may be slower. In various embodiments, the plasma is applied to the substrate at an operation speed ranging from about 4 cm/s to about 12 cm/s, from about 5 cm/s to about 11 cm/s, from about 6 cm/s to about 10 cm/s, from about 7 cm/s to about 9 cm/s, or about 8 cm/s.

As may be appreciated, the distance of the gap between a plasma probe and the substrate during the plasma treatment may vary and is dependent on the operation power of the plasma. For example, if the operation power is high, the gap may be larger. On the other hand, if the operation power is low, the gap may be smaller. In various embodiments when the plasma is applied to the substrate, the gap between a plasma probe and the substrate is from about 0.1 mm to about 0.8 cm, from about 0.2 mm to about 0.7 cm, from about 0.3 mm to about 0.6 cm, from about 0.4 mm to about 0.5 cm, from about 0.5 mm to about 0.4 cm, from about 0.6 mm to about 0.4 cm, from about 0.7 mm to about 0.3 cm, from about 0.8 mm to about 0.2 cm, from about 0.9 mm to about 0.1 cm, about 0.5 mm or about 0.5 cm.

Advantageously, surface adhesive strength and durability of the coating layer formed on the substrate are enhanced through the synergistic combination of plasma treatment and application of the surface functionalizing composition disclosed herein. In various embodiments, the method disclosed herein is capable of preparing a coated substrate with an improved adhesion strength, increased stability and prolonged adhesion duration as compared to conventional surface treatment/modification methods.

In various embodiments, the method further comprises, cleaning (e.g. by wiping) the surface of the substrate with an organic solvent prior to the step of subjecting the substrate to plasma. In various embodiments, cleaning the surface of the substrate includes wiping, rubbing or rinsing the surface of the substrate with an organic solvent. In certain embodiments, the cleaning step mainly removes loose contaminants and some organic compounds from the surface of the substrate. In certain embodiments, the cleaning step only partially removes the contaminants and does not completely remove all contaminants contained on the surface of the substrate. The organic solvent used for wiping the surface of the substrate may be a polar aprotic solvent such as acetone.

In various embodiments, the method further comprises, drying the layer of the composition after the layer of composition has been applied to the substrate. In some embodiments, the step of drying the layer of composition does not require an external application of heat or thermal energy. Accordingly, in some embodiments, drying the layer of composition comprises allowing the layer of composition to dry at room temperature for a time period of no more than about 60 minutes, no more than about 50 minutes, no more than about 40 minutes, no more than about 30 minutes, no more than about 25 minutes, no more than about 20 minutes, or no more than about 15 minutes. In some embodiments, the step of drying the layer of composition comprises gentle heating at a temperature that is no more than about 80° C., no more than about 70° C., no more than about 60° C., no more than about 58° C., no more than about 56° C., no more than about 54° C., no more than about 52° C., no more than about 50° C., no more than about 48° C., no more than about 46° C., no more than about 44° C., no more than about 42° C., no more than about 40° C., no more than about 38° C., no more than about 36° C., no more than about 34° C., no more than about 32° C., or no more than about 30° C. In some embodiments, drying the layer of composition comprises gentle heating the composition for a time period of no more than about 15 minutes, no more than about 10 minutes, no more than about 5 minutes, or no more than about 1 minute.

In various embodiments, the method further comprises, applying at least one of a primer layer, a topcoat layer or combinations thereof over the layer of the composition. In various embodiments, the step of applying at least one of a primer layer or a topcoat layer comprises adding a primer layer first, followed by topcoat layer. In various embodiments, the primer is applied as a preparatory coating or undercoat on the substrate so that the substrate is better prepared to receive the topcoat layer. In various embodiments, the objective of the primer is to prepare the substrate surface for applying with a topcoat. Therefore, the organosilane may be one that is capable of chemically reacting, chemically bonding or chemically coupling with one or more chemical/functional groups of primer. In various embodiments, the step of applying a primer layer over the layer of the composition comprises a reaction between the silane and the primer. Without being bound by theory, it is believed that, in various embodiments, the reaction comprises polar-polar interactions or dipole-dipole intermolecular forces/attractions. In various embodiments, the primer comprises polar groups. The primer may be a fluoroelastomer. The primer may be a liquid fluoroelastomer. The primer may be selected from the group consisting of perfluoroelastomers and tetrafluoroethylene/propylene rubbers. In various embodiments, the primer layer is prepared by mixing an accelerator and base materials at a ratio of from about 1:38 to about 1:50, at a ratio of from about 1:39 to about 1:49, at a ratio of from about 1:40 to about 1:48, at a ratio of from about 1:41 to about 1:47, at a ratio of from about 1:42 to about 1:46, at a ratio of from about 1:43 to about 1:45, or at a ratio of about 1:44. In various embodiments, the topcoat layer is prepared by mixing an accelerator and base materials at a ratio of from about 1:20 to about 1:34, at a ratio of from about 1:21 to about 1:33, at a ratio of from about 1:22 to about 1:32, at a ratio of from about 1:23 to about 1:31, at a ratio of from about 1:24 to about 1:30, at a ratio of from about 1:25 to about 1:29, at a ratio of from about 1:26 to about 1:28, or at a ratio of about 1:27. In some embodiments, the mixture of accelerator and base materials is subsequently stirred before allowed to evaporate, and applied to the substrate using a brush method. In some embodiments, the substrate having a primer layer is cured before said substrate is applied with a topcoat layer.

In various embodiments, the substrate comprises a solid substrate. In various embodiments, the solid substrate is selected from the group consisting of polymer, fabric, composite polymer, fiber reinforced polymer, the like and combinations thereof. In some embodiments, the substrate is a plastic composite. In one embodiment, the substrate is carbon fiber reinforced plastics.

In various embodiments, the substrate is contaminated with organic and/or inorganic contaminants. In various embodiments, the substrate is contaminated with one or more hydrocarbon(s). The hydrocarbon(s) may be one that is in a liquid state at room temperature. Therefore, in various embodiments, the contaminants are oil-based contaminants. In various embodiments, the contaminants are aviation-based or automobile-based contaminants that are commonly found in the aviation industries or automobile-based contaminants such as various oils or grease used in these industries. Therefore, in various embodiments, the substrate is a substrate that is used in the aviation or automobile-based industries. In various embodiments, the contaminant(s)/hydrocarbon(s) is selected from the group consisting of de-icing fluid, jet oil, jet fuel, hydraulic fluid and degreaser. In various embodiments therefore, the method disclosed herein can be used to coat substrates that are contaminated with a wide range of contaminants.

In various embodiments, the layer of composition or at least one of a primer layer, a topcoat layer or mixtures thereof is applied directly on the substrate in its contaminated form, i.e. when the substrate contains substantial amount of contaminants regardless of whether prior cleaning steps have been applied. In various embodiments therefore, the steps of the method are substantially devoid of a thorough cleaning process for the purposes of completely removing or substantially removing all contaminants from the contaminated substrate before use. In various embodiments therefore, the steps of the method are substantially devoid of a complicated or time-consuming surface pretreatment step. In various embodiments, the method is also substantially devoid of an abrasive pretreatment step such as sanding.

Advantageously, in various embodiments therefore, the method has an increased coating efficiency as a result of the synergistic combination of plasma treatment and application of the composition disclosed herein. In various embodiments, the method has an increased cleaning efficiency.

In various embodiments, there is provided a coated substrate comprising: a layer of the composition that is chemically coupled to a surface of the substrate. Various embodiments of the coated substrate form strong and permanent chemical bonds between the composition disclosed herein and activated site(s) of the substrate. Advantageously, embodiments of the coated substrate possess excellent adhesiveness between the substrate and the layer of the composition.

In various embodiments, the coated substrate further comprises a layer of at least one of a primer or a topcoat or combinations thereof that is chemically bonded to the layer of the composition. Various embodiments of the coated substrate form strong and permanent chemical bonds between the composition disclosed herein and the at least one of a primer layer or a topcoat layer or combinations thereof. In various embodiments, strong and permanent chemical bonds are formed between the composition disclosed herein and the primer layer. Advantageously, embodiments of the coated substrate also possess excellent adhesiveness between the at least one of a primer layer or a topcoat layer or combinations thereof and the layer of the composition.

In various embodiments, the coated substrate has a higher coating durability and coating adhesiveness as compared to a similar substrate that has not been coated with the composition disclosed herein or has not been treated with the method disclosed herein. In some embodiments, the coating layer comprising at least one of a primer layer, a topcoat layer or combinations thereof and a layer of composition is more durable as compared to that of a similar substrate that has not been coated with a composition disclosed herein or has not been treated with the method disclosed herein. In some embodiments, the coating layer comprising at least one of a primer layer or a topcoat layer and a layer of composition adhered well on the substrate for at least about 1 month, for at least about 2 months, for at least about 3 months, for at least about 4 months, for at least about 5 months, for at least about 6 months, for at least about 7 months, for at least about 8 months, for at least about 9 months, for at least about 10 months, for at least about 11 months or for at least about 12 months. In some embodiments, the coating layer comprising at least one of a primer layer or a topcoat layer and a layer of composition has a higher surface adhesion strength on the substrate as compared to that of a similar substrate that has not been coated with a composition disclosed herein or has not been treated with the method disclosed herein. In some embodiments, the coating layer comprising at least one of a primer layer or a topcoat layer and a layer of composition adhered well on the substrate for at least about 1 month, for at least about 2 months, for at least about 3 months, even after being subjected to harsh conditions for e.g. exposed to high temperatures at about 76° C. to about 100° C., at about 77° C. to about 99° C., at about 78° C. to about 98° C., at about 79° C. to about 97° C., at about 80° C. to about 96° C., at about 81° C. to about 95° C., at about 82° C. to about 94° C., at about 83° C. to about 93° C., at about 84° C. to about 92° C., at about 85° C. to about 91° C., at about 86° C. to about 90° C., at about 87° C. to about 89° C., or at about 88° C.

In various embodiments, the coated substrate has one or more of the following properties: cross-hatch classification of at least 4 as measured by cross-hatch tape test (ASTM D3359), adhesion strength of at least 2 MPa after 6 months of coating as measured by pull-off strength test (ASTM 4541D) at room temperature and adhesion strength of at least 2 MPa after 3 months of coating as measured by pull-off strength test (ASTM 4541D) at 88° C.

In various embodiments, the coated substrate has a cross-hatch classification of at least 2, at least 3, at least 4 or at least 5 as measured by cross-hatch tape test (ASTM D3359). In various embodiments, the coated substrate has a cross-hatch classification of about 5 even after a year of coating and are thermally stable up to 88° C. for at least about 3 months of coating. Advantageously, the compositions disclosed herein according to embodiments disclosed herein are a new class of surface treatment agents that can be used in a wide array of applications in the coating industry.

### BRIEF DESCRIPTION OF FIGURES

FIG. 1 is a schematic flowchart for illustrating a method of coating a substrate in accordance with various embodiments disclosed herein.

FIG. 2 shows the cross-hatch patterns of different coated substrates in accordance with various embodiments disclosed herein. The cross-hatch patterns are obtained according to the cross-hatch tape test (ASTM D3359).

FIGS. 3A-3D show the cross-hatch test results (in terms of cross-hatch classification) for different coated substrates in accordance with various embodiments disclosed herein. The cross-hatch classification is rated from 0 to 5 by evaluating the respective cross-hatch patterns obtained in FIG. 2 against the rating scale described in ASTM D3359.

FIGS. 4A-4D show the pull-off test results (in terms of adhesion strength in MPa) for different coated substrates in accordance with various embodiments disclosed herein. The adhesion strength was evaluated according to ASTM 4541D at room temperature.

FIGS. 5A-5D show the pull-off test results (in terms of adhesion strength in MPa) for different coated substrates in accordance with various embodiments disclosed herein. The adhesion strength was evaluated according to ASTM 4541D at elevated temperature (88° C.).

### DETAILED DESCRIPTION OF FIGURES

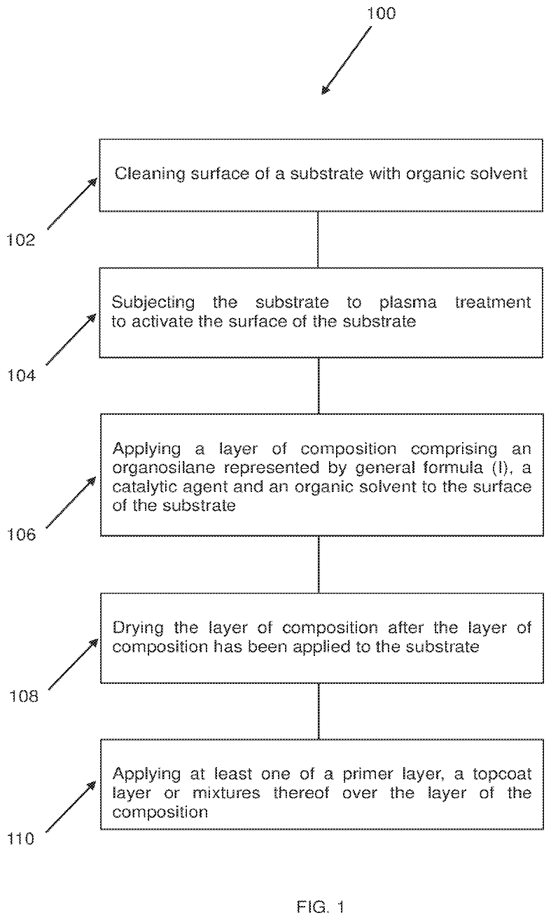

FIG. 1 is a schematic flowchart 100 for illustrating a method of coating a substrate in accordance with various embodiments disclosed herein. At step 102, a surface of a substrate is cleaned with organic solvent, for e.g. acetone. At step 104, the cleaned substrate is subjected to plasma treatment to activate the surface of the substrate. At step 106, a layer of composition comprising an organosilane represented by general formula (I), a catalytic agent and an organic solvent is applied to the surface of the substrate. At step 108, the layer of composition is dried after the layer of composition has been applied to the substrate at step 106. At step 110, at least one of a primer layer, a topcoat layer or mixtures thereof is/are applied over the layer of the composition to form a coated substrate in accordance with various embodiments disclosed herein. In various other embodiments, any one of steps 102, 104, 108 may be optional.

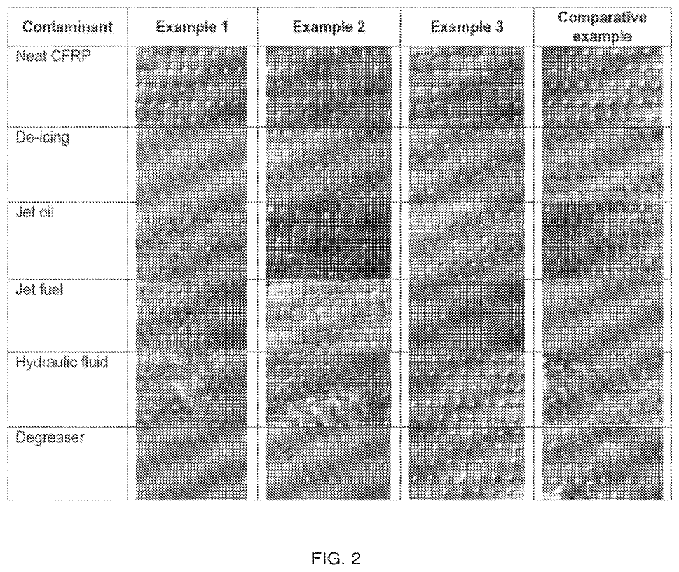

FIG. 2 shows the cross-hatch patterns of different coated substrates in accordance with various embodiments disclosed herein. The coated substrates (Substrate #1: uncontaminated CFRP; Substrate #2: CFRP contaminated with de-icing fluid; Substrate #3: CFRP contaminated with jet oil; Substrate #4: CFRP contaminated with jet fuel; Substrate #5: CFRP contaminated with hydraulic fluid; Substrate #6: CFRP contaminated with jet fuel) have been treated with different methods (Example 1: Atmospheric plasma treatment; Example 2: Surface functionalizing agent treatment; Example 3: Combination of atmospheric plasma treatment and surface functionalizing agent treatment; Comparative Example: Wiped with acetone). The cross-hatch patterns are obtained according to the cross-hatch tape test (ASTM D3359).

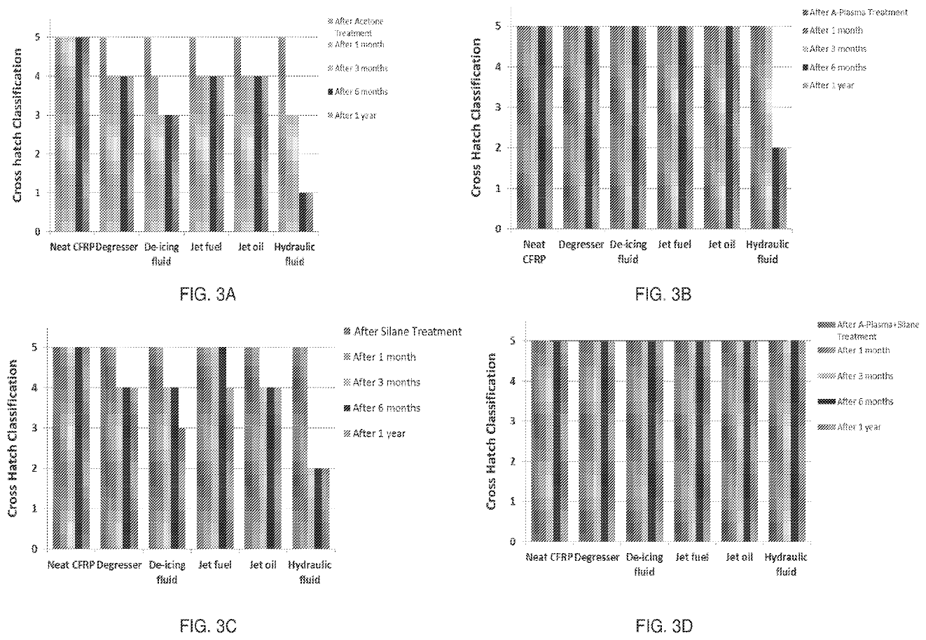

FIGS. 3A-3D show the cross-hatch test results (in terms of cross-hatch classification) for different coated substrates in accordance with various embodiments disclosed herein. The cross-hatch classification is rated from 0 to 5 by evaluating the respective cross-hatch patterns obtained in FIG. 2 against the rating scale described in ASTM D3359. In FIG. 3A, the coated substrates (Substrate #1: uncontaminated CFRP; Substrate #2: CFRP contaminated with de-icing fluid; Substrate #3: CFRP contaminated with jet oil; Substrate #4: CFRP contaminated with jet fuel; Substrate #5: CFRP contaminated with hydraulic fluid; Substrate #6: CFRP contaminated with jet fuel) have been treated with acetone. In FIG. 3B, the coated substrates have been treated with plasma. In FIG. 3C, the coated substrates have been treated with silane surface functionalizing agent. In FIG. 3D, the coated substrates have been treated with a combination of plasma and silane surface functionalizing agent.

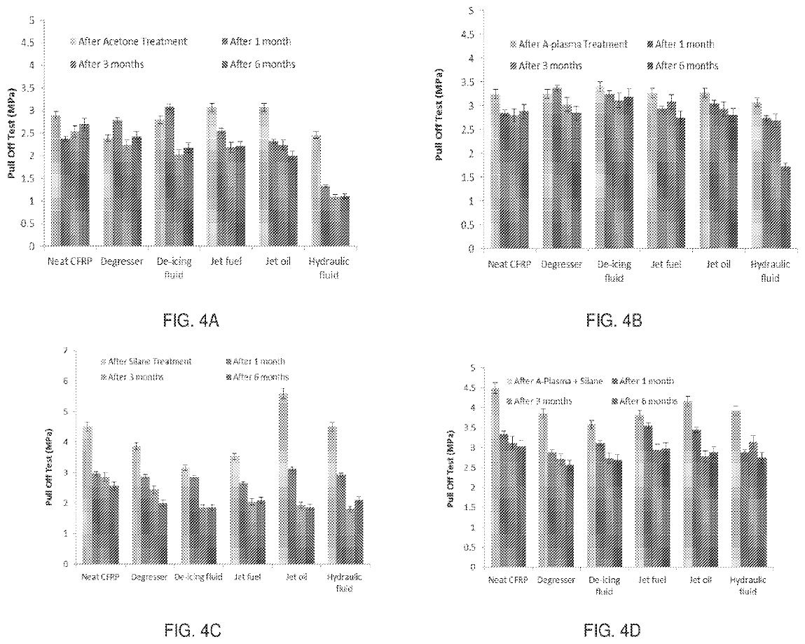

FIGS. 4A-4D show the pull-off test results (in terms of adhesion strength in MPa) for different coated substrates in accordance with various embodiments disclosed herein. The adhesion strength was evaluated according to ASTM 4541D at room temperature. In FIG. 4A, the coated substrates (Substrate #1: uncontaminated CFRP; Substrate #2: CFRP contaminated with de-icing fluid; Substrate #3: CFRP contaminated with jet oil; Substrate #4: CFRP contaminated with jet fuel; Substrate #5: CFRP contaminated with hydraulic fluid; Substrate #6: CFRP contaminated with jet fuel) have been treated with acetone. In FIG. 4B, the coated substrates have been treated with plasma. In FIG. 4C, the coated substrates have been treated with silane surface functionalizing agent. In FIG. 4D, the coated substrates have been treated with a combination of plasma and silane surface functionalizing agent.

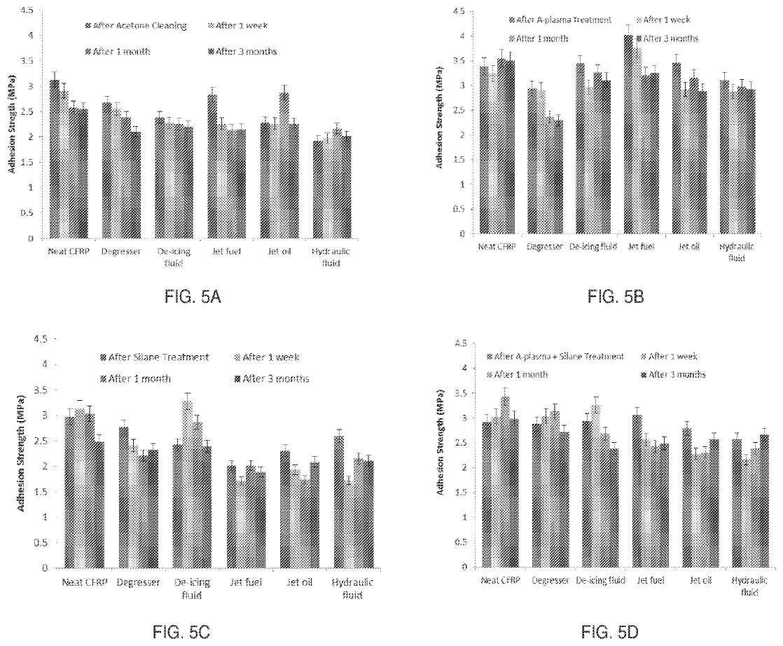

FIGS. 5A-5D show the pull-off test results (in terms of adhesion strength in MPa) for different coated substrates in accordance with various embodiments disclosed herein. The adhesion strength was evaluated according to ASTM 4541D at elevated temperature (88° C.). In FIG. 5A, the coated substrates (Substrate #1: uncontaminated CFRP; Substrate #2: CFRP contaminated with de-icing fluid; Substrate #3: CFRP contaminated with jet oil; Substrate #4: CFRP contaminated with jet fuel; Substrate #5: CFRP contaminated with hydraulic fluid; Substrate #6: CFRP contaminated with jet fuel) have been treated with acetone. In FIG. 5B, the coated substrates have been treated with plasma. In FIG. 5C, the coated substrates have been treated with silane surface functionalizing agent. In FIG. 5D, the coated substrates have been treated with a combination of plasma and silane surface functionalizing agent.

### EXAMPLES

Example embodiments of the disclosure will be better understood and readily apparent to one of ordinary skill in the art from the following examples, tables and if applicable, in conjunction with the figures.

The examples describe a method of coating a substrate in a fast and straightforward process in accordance with various embodiments of the present disclosure. As will be shown in the following examples, embodiments of the presently disclosed method provide a cost-effective and environmentally friendly strategy to produce coated substrates as a cleaning process for the complete removal of contaminants, use of abrasive pretreatment methods such as sanding and harsh chemical treatment methods for surface treatment were avoided. In summary, embodiments of the presently disclosed method require easy preparation.

As will be shown in the following examples, embodiments of the composition disclosed herein can be carefully tuned (through customisation of the functional groups present in the organosilane coupling agent) to be applied on many different types of substrates with varying functional groups. Substrates coated according to embodiments of the method disclosed herein have a higher coating adhesiveness and coating durability as compared to a similar substrate that has not been coated with the composition disclosed herein and/or treated with plasma in accordance with embodiments of the method disclosed herein. These coated substrates have high surface adhesion strength (i.e. have a cross-hatch classification of about 5 even after a year of coating) and are highly durable (i.e. thermally stable up to 88° C. after 3 months of coating).

As will also be shown in the following examples, embodiments of the method disclosed herein are capable of coating substrates that are contaminated with a wide range of inorganic and/or organic contaminants and yet still maintain high coating adhesiveness and good coating durability in the coated substrates.

Materials and Methodology

In the examples, the substrate is carbon fiber reinforced plastics (CFRP), prepared from woven carbon fiber fabric (Toray T300) and epoxy plastic thermoset. Neat epoxy (D.E.R. 332) and hardener (Ethacure 100LC) were mixed at the weight ratio of 100:26. The resin was applied onto carbon fiber fabric using a wet layup process. The laminated CFRP was cured using a hot-pressed vacuum process and the curing condition was at a temperature from 130° C. to 230° C. with pressure increasing from 0 to 61 bar. The sample thickness is about 3 mm. After that, the sample was contaminated with different types of chemicals: (1) de-icing fluid, (2) jet oil, (3) jet fuel, (4) hydraulic fluid, and (5) degreaser. The CFRP was dipped into the respective contaminant solution for 1 h under static condition. After that, the CFRP was baked in oven at elevated temperature for 8 h, then cooled down to room temperature. After that, the sample was redipped into the contaminant again and the process was repeated up to 20 cycles. The contaminated sample was cleaned using different methods (as described in the following Examples 1, 2, 3 and Comparative Example) before coated with a fluoroelastomer primer, followed by a top-coat. The primer was prepared with accelerator and base materials in the ratio of 1:44 respectively. The mixture was stirred before allowing it to evaporate for 10 minutes. The mixture was then applied onto the substrate using a brush method before curing in the oven for 20 minutes at 149° C. Similar procedures were repeated for top-coat with the same accelerator and base materials in the ratio of 1:27 to be applied on the cured primer.

Developed Solution

The developed solution was prepared with 10 mL of acetone, 0.2 mL of aminopropyltriethoxysilane (APTES) and 0.15 ml of ethanolamine (ETA).

Characterization

Surface adhesion strength between coating and substrate was evaluated using (1) cross-hatch tape (ASTM D3359) and (2) pull-off strength test (ASTM 4541D). The adhesion strength was tested up to 6 months under two environmental conditions: at room temperature and elevated temperature (88° C.).

### Example 1

### Atmospheric Plasma Treatment

The neat CFRP and contaminated CFRPs were wiped with acetone before treated using atmospheric plasma (Tantec Plasma TEC System, Max 15 kV, probe Ø 4 mm). The operation power was up to 2000 W and the operation speed was 8 cm/s. The gap between the plasma probe and the substrate was approx. 0.5 cm. After that, the sample was cooled down to room temperature before coating with fluoroelastomer primer, followed by top-coat using the methods mentioned in the materials and methodology section.

### Example 2

### Surface Functionalizing Agent Treatment

The neat CFRP and contaminated CFRPs were wiped with acetone before the developed solution was sprayed on the surface of the CFRP. After 30 min, the sample was coated with fluoroelastomer primer, followed by top-coat using the methods mentioned in the materials and methodology section.

### Example 3

### Combination of Atmospheric Plasma Treatment and Surface Functionalizing Agent Treatment

The neat CFRP and contaminated CFRPs were wiped with acetone before the developed solution was sprayed on the surface of the CFRP. After 30 min, the sample was coated with fluoroelastomer primer, followed by top-coat using the methods mentioned in the materials and methodology section.

### Comparative Example

### Neat CFRP and Contaminated CFRP Cleaned with Acetone (Currently Used Method)

The neat CFRP and contaminated CFRPs were wiped with acetone. After the sample surface was dried, the sample was coated with fluoroelastomer primer, followed by top-coat using the methods mentioned in the materials and methodology section.

### Adhesion Strength Between Coating and Substrate Treated by Different Methods Described in Examples 1, 2, 3 and Comparative Example

The adherability of the coating to the substrates (i.e. neat CFRP and contaminated CFRPs) that are treated by different methods described in Examples 1, 2, 3 and the Comparative Example was evaluated using the cross-hatch tape (ASTM D3359) and the pull-off strength test (ASTM 4541).

### (i) Cross-Hatch Tape (ASTM D3359)

FIG. 2 shows the cross-hatch patterns obtained according to the cross-hatch tape test (ASTM D3359). In FIGS. 3A-3D, the results show that the coating adhered well on the CFRP substrate and the coating adhered well up to 12 months. Interestingly, for the CFRP and contaminated CFRPs treated by atmospheric plasma, following by surface functionalizing agent treatment (see FIG. 3D), no peeling of the coating was observed after 12 months. This result suggests that using the surface functionalizing agent treatment can enhance the adhesion strength. Without being bound by theory, it is believed that this is possible due to the interaction between the surface functional groups on the substrate and the coating. Without being bound by theory, it is also believed that the interaction may involve reaction(s) between the one or more functional groups of the organosilane coupling agent and the polar groups of the primer/coating layer.

Another interesting observation is that the substrates treated with other methods (i.e. acetone, plasma treatment and silane modification shown respectively in FIGS. 3A to 3C) show relatively poor performance when the CFRP is contaminated with hydraulic fluid as compared to CFRP contaminated with other contaminants (i.e. de-icing fluid, jet oil, jet fuel and degreaser). The coating on the CFRP (contaminated with hydraulic fluid) after cleaning by acetone (see FIG. 3A) peeled out after one week, whereas peeling of the coating on the CFRP (contaminated with hydraulic fluid) treated by plasma treatment (see FIG. 3B) was observed after six months. No peeling of the coating was observed for the CFRP contaminated with other contaminants (i.e. de-icing fluid, jet oil, jet fuel and degreaser). With this result, it is believed that the mechanism of coating adhesion between the cleaned CFRP and coating is subjected to the nature of contaminants. It is possible that the reaction between different contaminates and plasma generates different surface property. Without being bound by theory, it is believed that a possible mechanism of the coating adhesion is polar-polar interaction(s) between one or more functional groups of the silane in the developed solution and one or more polar groups of the primer layer.

### (ii) Pull-Off Strength Test (ASTM 4541 D) at Room Temperature

The adhesion strength between coating and substrates treated by different methods was also evaluated using pull-off strength test (ASTM 4541D) and the results are presented in FIGS. 4A-4D. The results show that the adhesion strength gradually decreased with time, especially silane modification without atmospheric plasma treatment (see FIG. 4C), which shows that the adhesion strength abruptly declined. It is interesting to note that the adhesion strength was relatively consistent for the samples treated with plasma treatment (see FIG. 4B). For the samples treated with atmospheric plasma, followed by silane treatment (see FIG. 4D), the adhesion strength gradually decreased at the initial stage, and slowly decreased at a reduced rate over the span of 6 months. Nonetheless, as it can be seen, the adhesion strength between the coating and the substrates treated with plasma followed by silane (shown in FIG. 4D) is still high as compared to the samples treated by conventional method (as shown in FIG. 4A).

(iii) Pull-Off Strength Test (ASTM 4541D) at Elevated Temperature (88° C.)

The adhesion strength between coating and substrates treated by different methods was also evaluated using pull-off strength test (ASTM 4541D) at elevated temperature. The results are presented in FIGS. 5A-5D. Like at room temperature (c.f. FIG. 4), the results show that the adhesion strength gradually decreased by time, especially those treated with silane modification without atmospheric plasma treatment (see FIG. 5C) and conventional method (see FIG. 5A). However, the adhesion strength was still in the high band (more than about 2 MPa) after 3 months, except the sample treated by silane modification without atmospheric plasma treatment and conventional method, which started reaching low band (less than about 2 MPa).

### Applications

Various embodiments of the present disclosure provide a simple, fast and straightforward method of preparing/coating a substrate by using a composition comprising organosilane coupling agent, catalytic agent and organic solvent disclosed herein. In various embodiments, the composition disclosed herein can be incorporated into existing treatment processes with ease. In various embodiments of the method of coating the substrate, the composition can be carefully tuned (through customisation of the functional groups present in the organosilane coupling agent) to be applied on many different types of substrates with varying functional groups, thus making the composition disclosed herein attractive for use as surface functionalising agents.

In various embodiments therefore, the composition disclosed herein overcomes the challenges of conventional plastic surface treatment methods. In various embodiments therefore, the compositions disclosed herein are a new class of surface treatment agents that can be used in a wide array of applications in the coating industry.

Advantageously, various embodiments of the coated substrate disclosed herein have shown that the surface adhesive strength and durability of the coating layer formed on the substrate are enhanced through the synergistic combination of plasma treatment and application of the composition disclosed herein. Various embodiments of the method disclosed herein are capable of coating substrates that are contaminated with a wide range of inorganic and/or organic contaminants and yet still maintain high coating adhesiveness and good coating durability in the coated substrates. In these embodiments, the compositions and methods disclosed herein can be scalable for industrial applications in substrate cleaning and fabrication.

In various embodiments of the method of coating a substrate disclosed herein, the process does not involve the use of a cleaning process for complete removal of contaminants from the substrates and use of abrasives for pre-treating substrates, thereby making the coating process cost-effective and economical on a large scale.

In various embodiments of the method of coating a substrate disclosed herein, the process does not involve the use of harsh chemical treatment methods, thereby making the coating process friendly to the environment.

The present disclosure has demonstrated the principles involved, and opens the way for further scale-up in many applications.

It will be appreciated by a person skilled in the art that other variations and/or modifications may be made to the embodiments disclosed herein without departing from the spirit or scope of the disclosure as broadly described. For example, in the description herein, features of different exemplary embodiments may be mixed, combined, interchanged, incorporated, adopted, modified, included etc. or the like across different exemplary embodiments. The present embodiments are, therefore, to be considered in all respects to be illustrative and not restrictive.

1. A method of coating a substrate, the method comprising:
subjecting a substrate to plasma treatment to activate a surface of the substrate; and
applying a layer of a composition comprising:
(i) an organosilane represented by general formula (I):
(Y—R)ₙSiXₘ
wherein
each of Y is independently a chemical moiety that is capable of chemically coupling to a functional group of the coating layer;
each of R is independently a C₃₋₁₈ alkyl group;
each of X is independently a C₁₋₆ alkoxy group;
n is 1, 2 or 3;
m is 1, 2 or 3; and wherein
n+m=4;
(ii) a catalytic agent; and
(iii) an organic solvent to the surface of the substrate.

2. The method according to claim 1, wherein the plasma treatment is atmospheric plasma treatment.

3. The method according to claim 1, further comprising, cleaning the surface of the substrate with an organic solvent prior to the step of subjecting the substrate to plasma treatment.

4. The method according to claim 1, further comprising, drying the layer of the composition after the layer of composition has been applied to the substrate.

5. The method according to claim 1, further comprising, applying at least one of a primer layer, a topcoat layer or mixtures thereof over the layer of the composition.

6. The method according to claim 1, wherein the substrate is selected from the group consisting of polymer, fabric, composite material, fiber reinforced polymer.

7. The method according to claim 6, wherein the substrate comprises carbon fiber reinforced plastics.

8. The method according to claim 1, wherein the substrate is contaminated with organic and/or inorganic contaminants.

9. The method according to claim 8, wherein the substrate is contaminated with one or more hydrocarbon(s) selected from the group consisting of de-icing fluid, jet oil, jet fuel, hydraulic fluid and degreaser.

10. The method according to claim 1, wherein an amount of organosilane present is in a range of 0.1 wt % to 22.5 wt %.

11. The method according to claim 1, wherein an amount of catalytic agent present is in a range of 0.1 wt % to 2.7 wt %.

12. The method according to claim 1, wherein an amount of organic solvent present is in a range of 0.1 wt % to 97.4 wt %.

13. The method according to claim 1, wherein each of Y is a chemical moiety independently selected from the group consisting of amine, halogen, vinyl, acryloyloxy, glycidyloxy, hydrogen and aryl.

14. The method according to claim 1, wherein the organosilane comprises an aminoalkyl alkoxysilane compound selected from the group consisting of aminopropyltrimethoxysilane, aminobutyltrimethoxysilane, aminopentyltrimethoxysilane, aminohexyltrimethoxysilane, aminopropyltriethoxysilane, aminopropyltripropoxysilane, aminopropyltributoxysilane, aminopropyltripentoxysilane, aminopropyltrihexoxysilane, aminobutyltriethoxysilane, aminobutyltripropoxysilane, aminobutyltributoxysilane, aminobutyltripentoxysilane, aminobutyltrihexoxysilane, aminopentyltriethoxysilane, aminopentyltripropoxysilane, aminopentyltributoxysilane, aminopentyltripentoxysilane aminopentyltrihexoxysilane, aminohexyltriethoxysilane, aminohexyltripropoxysilane, aminohexyltributoxysilane, aminohexyltripentoxysilane, aminohexyltrihexoxysilane and combinations thereof.

15. The method according to claim 1, wherein the catalytic agent comprises a base selected from the group consisting of methanolamine, ethanolamine, diethanolamine, triethanolamine, propanolamine, butanolamine, trimethylamine, triethylamine, tripropylamine, tributylamine, ammonium hydroxide, tetramethylammonium hydroxide, tetraethylammonium hydroxide, tetrapropylammonium hydroxide, tetrabutylammonium hydroxide and combinations thereof.

16. The method according to claim 1, wherein the organic solvent is selected from the group consisting of acetone, ethyl acetate, ethyl alcohol, benzene, toluene, xylene, styrene and combinations thereof.
